(19) United States
(12) Patent Application Publication
(10) Pub. No.: US 2014/0123710 A1
(43) Pub. Date: May 8, 2014

(54) APPARATUS AND METHOD FOR MINIMIZING PLATINUM GROUP METAL PARTICULATE INCLUSION IN MOLTEN GLASS

(71) Applicants: David Myron Lineman, Painted Post, NY (US); Matthew Carl Morse, Campbell, NY (US)

(72) Inventors: David Myron Lineman, Painted Post, NY (US); Matthew Carl Morse, Campbell, NY (US)

(21) Appl. No.: 13/667,595

(22) Filed: Nov. 2, 2012

(51) Int. Cl. C03B 5/225

(52) U.S. Cl. 65/135.1; 65/346

(57) ABSTRACT

An apparatus used in the production of glass, and a process for minimizing the inclusion of platinum group metal particulate into molten glass during glass production are provided, the apparatus comprising a first conduit formed of a platinum group metal, the first conduit comprising a top wall portion, a side wall portion, an outer surface, and a length, and a heat sink formed of a platinum group metal and affixed continuosly to the outer surface and extending longitudinally along at least part of the length of the first conduit proximate the top wall portion for the dissipation of heat therefrom, wherein the inner volume has a maximum temperature, T(max inside top wall), and the inner surface proximate the heat sink has a lower temperature, T(min inside top wall), and wherein platinum group metal particulate formed during the production process will deposit on the inner surface area of the top wall portion not in contact with the molten glass.

### TECHNICAL FIELD

The disclosure relates generally to the field of glass production, and more particularly to an apparatus and method for minimizing the inclusion of platinum group metal particulate matter into molten glass during the glass manufacturing process.

### BACKGROUND

A system 100 for making glass comprises a series of interconnected components, as illustrated in the schematic of FIG. 1, and begins with the melting of raw stock material 124 in a furnace, or melting vessel 102, formed of refractory materials. The molten glass 126 is conveyed downstream from the melting vessel 102 via a melting vessel to finer connecting tube 104 to a conduit, or finer 106, where the molten glass is further heated to temperatures exceeding 1,600 degrees C. From the finer 106, the molten glass 126 is conveyed through a finer to stir chamber connecting tube 108 to stir chamber 110. From the stir chamber, the molten glass 126 is conveyed to the delivery vessel 114 via the stir chamber to delivery vessel connecting tube 112, wherein it passes through a downcomer 116, through an inlet 118, and into a forming body 120, from which a glass ribbon 122 is formed. Because such high temperatures are necessary for the glass manufacturing process, the finer 106, other conduits 108, 112, stir chamber 110, etc. of the system 100 are formed from platinum or platinum alloys, such as platinum/rhodium. In one exemplary embodiment of the system, the system components comprise platinum group metals, which may include platinum, rhodium, palladium, iridium, rhenium, ruthenium, and osmium.

Flat display devices such as liquid crystal displays (LCDs) are made from flat glass substrates or sheets formed from molten glass. Reactions which occur during the melting stage release gases which form bubbles in the glass melt. Seeds may also be generated by interstitial air trapped between particles of the feed materials. In any event, these gas bubbles and seeds (collectively referred to herein as gaseous inclusions) must be removed to produce high quality glass. The removal of gaseous inclusions is generally accomplished by “fining” the glass melt. For clarity, gaseous inclusions formed as a result of the melting process, whether as reaction products or interstitial gases, may also be referred to as “blisters” or “bubbles.”

A common method of fining a glass melt is by chemical fining. In chemical fining, a fining agent is introduced into the glass melt, such as by addition to the feed material. The fining agent may be a multivalent oxide material that is reduced (loses oxygen) at high temperatures, and is oxidized (recombines with oxygen) at low temperatures. Oxygen released by the fining agent may then diffuse into the seeds formed during the melting process causing seed growth. The buoyancy of the seeds is thereby increased, wherein they rise to the surface of the glass where the gas is released out of the melt. Ideally, it is desirable that the fining agent releases oxygen late in the melting process, after most of the seeds have formed, thereby increasing the effectiveness of the fining agent. To that end, although large seeds may be eliminated in the melting vessel, the glass typically undergoes additional fining in a fining vessel, where the temperature of the glass melt is typically increased above the melting temperature. The increase in temperature of the glass melt within the fining vessel reduces the viscosity of the glass, making it easier for seeds in the glass melt to rise to the surface of the glass, and a multivalent oxide fining agent will release a fining gas (oxygen) to the glass melt to cause seed growth and assist with the seed removal process. Once the glass melt has been fined, it may be cooled and stirred, and thereafter formed, such as into a glass sheet, through any one of a variety of available forming methods known in the art.

At temperatures above about 1000 degrees C., however, released oxygen from the fining process, or present in the open finer since the finer is open to ambient air through a vent, causes exposed platinum group metal particulates from the inner surfaces of the system components to oxidize according to the following equations:

Pt₍ₛ₎+O_{2(g)}<->PtO_{2(g)}

Rh(s)+O_{2(g)}<->RhO_{2(g)}

Similar oxidation/reduction reactions occur with other platinum group metals. Platinum and rhodium are shown here as examples. If the temperature is lower in one part of the system than another, then some of the PtO₂ and RhO₂ gas will be reduced into platinum and rhodium or combination of metal particulates. If this platinum and rhodium particulate deposits or accumulates on the molten glass, then the glass surface of the subsequently formed glass sheet may include these particles, resulting in an unacceptable finished glass sheet. Alternatively, if the exposed platinum and rhodium surfaces above the molten glass line are cooler, then the particulate matter is most likely to deposit thereon, forming a strong diffusion bond on the platinum or platinum/rhodium surfaces, thus significantly reducing the amount of platinum or platinum/rhodium particulate that may be included in the molten glass.

### SUMMARY

FIG. 2 best illustrates an exemplary finer 106 in a glass manufacturing system. As shown, the finer 106 illustrated in the embodiment of FIG. 1 is a cylindrical conduit, or vessel, extending longitudinally between a pair of flanges 107. Once molten glass 126 (FIG. 3) is conveyed into the finer 106, the circumferential flanges serve as connection points at each end of the finer for passing electrical current through the finer to further increase the temperature of the molten glass. Each flange 107 also is formed of platinum group metals and is bonded to the finer by a continuous weld, with the flanges 107 typically spaced sufficiently apart to permit sufficient passage of electrical current therethrough. Because this process generates heat, a circumferential tube 107a can be mounted around the circumference each flange for cooling water to flow therethrough to cool the flanges 107. It has been found that this cooling of the flanges causes the flanges to act as heat sinks to dissipate heat away from each end of the finer 106. As a result, this lowers the temperature proximate the inner surface of the finer where it is attached to the finer outer surface. In one embodiment of the system 100, for example, testing revealed temperature differential of approximately 65 degrees C. between the midway point between the flanges and the flange. As best shown in FIG. 3, and as described above, this temperature drop was found to cause platinum group metal particulate matter, P, to bond to the inner surface of the finer only under the flange area that was cooler than the surrounding inner surface area of the finer. It was subsequently determined, however, that heat transfer through the flange and the deposition of the particulate matter under the flange would not be possible without substantially direct continuous contact between the outer surface of the finer flange and the flange via a continuous weld. While a finer may include a reinforcing rib 106a that extends longitudinally along the upper outer surface of the finer 106 to provide structural support to the finer during high temperature operation, i.e., to prevent sagging, such depositions of particulate did not occur beneath the reinforcing rib. The lack of particle growth within the inner surface of the finer beneath the rib has been attributed to non-continuous contact between the finer and the rib in that the reinforcing rib 106a is only spot-welded to the top of the finer, i.e., there are gaps between the finer outer surface and the rib. Thus, heat cannot effectively dissipate from the finer to the rib without solid material to conduct through.

As will be appreciated, while the deposition or bonding of platinum or platinum/rhodium particulate matter on the inner surfaces of the finer, or other system component, results in a shortened equipment lifetime, any particulate that does accumulate on the inner surfaces of the finer, or other system components, that are not in contact with the molten glass 126 significantly reduces the amount of particulate available to form inclusions in the molten glass 126. As a result, and to the extent that less platinum or platinum/rhodium inclusions/depositions do not get into the molten glass 126, the quality and quantity of finished glass sheets increases. Nonetheless, because the flanges in one embodiment are greater than a meter apart, there is substantial molten glass surface area between the flanges where the particulate form or deposit on the surface of the molten glass.

Thus, one aspect of the present disclosure is directed to an apparatus used in the manufacture of glass, which will facilitate reduction of undesirable particulate on or in the molten glass in the space between the flanges. The apparatus comprises a first conduit, such as a finer, which is formed of platinum group metals, such as platinum/rhodium, and comprises a top wall portion, a side wall portion, an outer surface, and a length. A heat sink, also formed of platinum group metals, or other material of sufficient thermal conductivity, is affixed directly and substantially continuously to the outer surface of the first conduit and extends longitudinally along at least a portion of the length of the first conduit, proximate the top wall portion for the dissipation of heat therefrom. As used herein, the term “heat sink” refers to a material that is added to an apparatus or device for the purpose of absorbing and dissipating heat. The heat sink material may comprise one or a combination of forms, including solids, liquids, or gasses. Also, as used herein, the term “continuously” means uninterrupted, unbroken, and without substantial gaps or openings. In one embodiment, this means at least about 70% of the heat sink is in direct contact with the first conduit.

A further aspect of the present disclosure is directed to a process for minimizing the inclusion of platinum group metal particles into molten glass during glass manufacture in a system comprising platinum group metal components, such as vessels, conduits, standpipes, etc. The method comprises the step of processing or conveying molten glass through a conduit or vessel, wherein the conduit or vessel comprises a top wall portion not in direct contact with the molten glass, a side wall portion that is in direct contact with the molten glass, and an inner surface area. A heat sink is located on the outside top wall portion of the conduit or vessel which is not in direct contact with the molten glass. When the molten glass formed during the manufacturing process is conveyed or held within the conduit or vessel, the heat sink creates a selected temperature differential between the maximum temperature in the conduit or vessel and the heat sink. Furthermore, the heat sink creates cold spots inside the conduit or vessel top wall portion. The heat sinks/cold spots are designed such that they are in close proximity to the hottest areas inside the top wall portion of the conduit or vessel. Thus, particulate formed during the manufacturing process will form, or deposit, on the inner surface cold spots of the top wall portion not in contact with the molten glass. In an embodiment, this comprises deposition on the top wall portion between about 5% and 50% of the top wall surface area not in contact with the molten glass 126. In other words, in an embodiment the cold spot comprises 5% to 50% of the top wall surface above the glass. It has been found that a temperature differential (between the hot and cold spots inside the conduit or vessel) as high as 150 degrees C. will create the desired effect; however, in one embodiment, the temperature differential, T(max inside top wall)−T(min inside top wall) is between 10 degrees C. and 50 degrees C. A lower temperature differential permits the system temperature within the vessel to be maximized, but maintained below the melting point of the platinum group metal.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a flow diagram of an exemplary glass manufacturing system in accordance with an embodiment of the present disclosure;

FIG. 2 is a perspective view of a first conduit, or finer, according to the present disclosure;

FIG. 3 is an environmental cross-sectional view of the first conduit of FIG. 2, illustrating the deposition of platinum or platinum alloy on the upper, top, inner surface thereof;

FIG. 4 is a perspective view of one embodiment of a heat sink formed as a cooling fin for dissipating heat from the top side of the first conduit of FIG. 2;

FIG. 5 is a perspective view of the embodiment of FIG. 4, with the addition of a cooling conduit;

FIG. 6 is a perspective view of an alternative embodiment of FIG. 4, illustrating multiple cooling fins for dissipating heat from the top side of the first conduit of FIG. 2;

FIG. 7 is a perspective view of another alternative embodiment of a heat sink formed as a coolant conduit;

FIG. 8 is a perspective view of another alternative embodiment of a heat sink formed as a coolant channel; and

FIG. 9 is a perspective view of a second, vertical conduit, having multiple cooling fins affixed thereto.

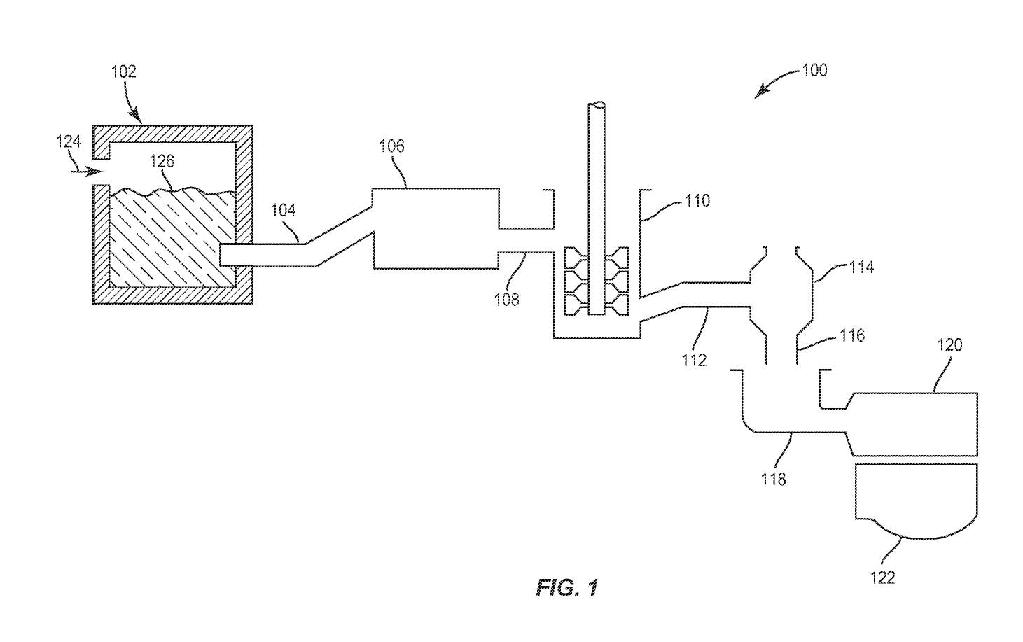

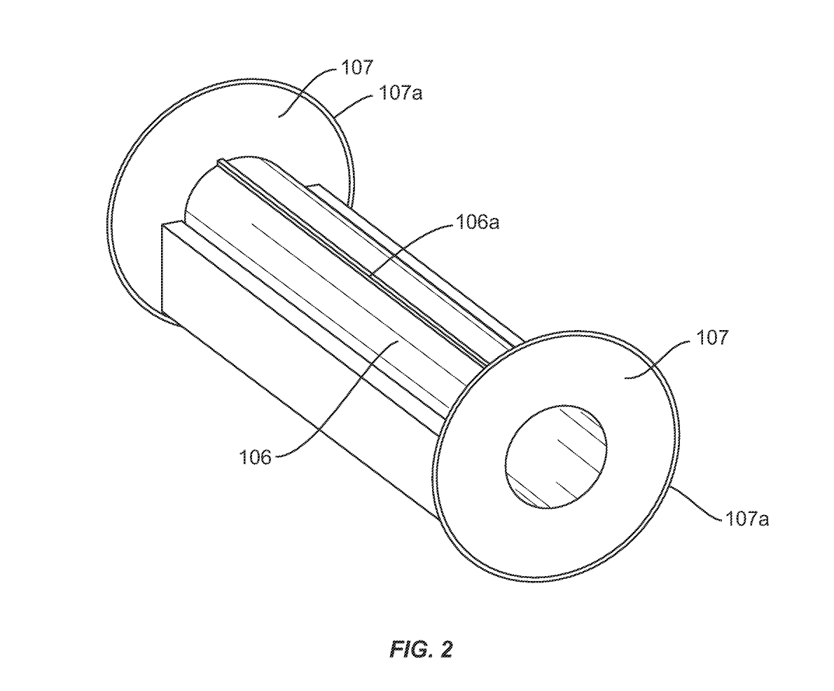

### DETAILED DESCRIPTION

Examples will now be described more fully herein with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

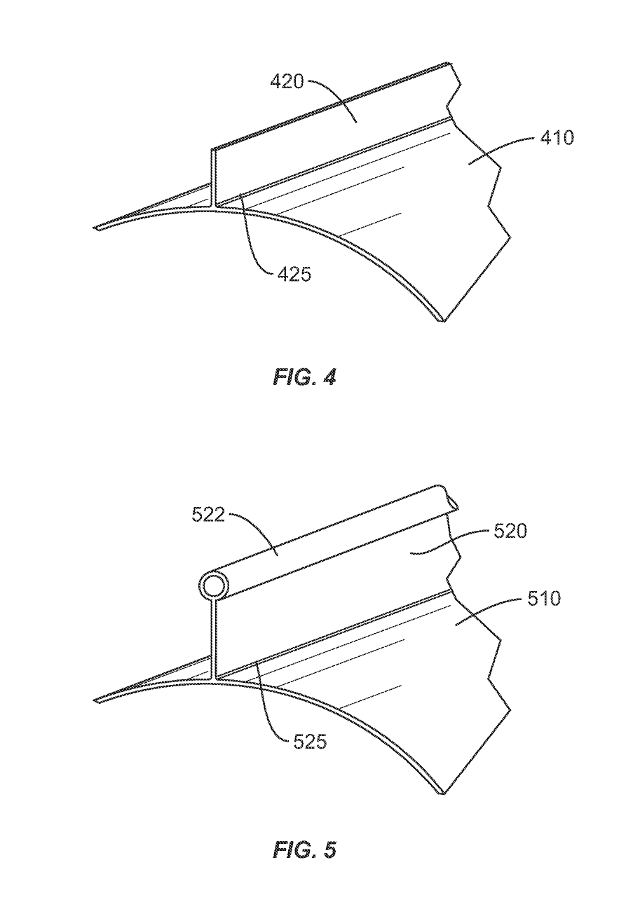

Referring now in general to FIGS. 4 through 9, several exemplary embodiments of the present disclosure are shown, and will be described herein.

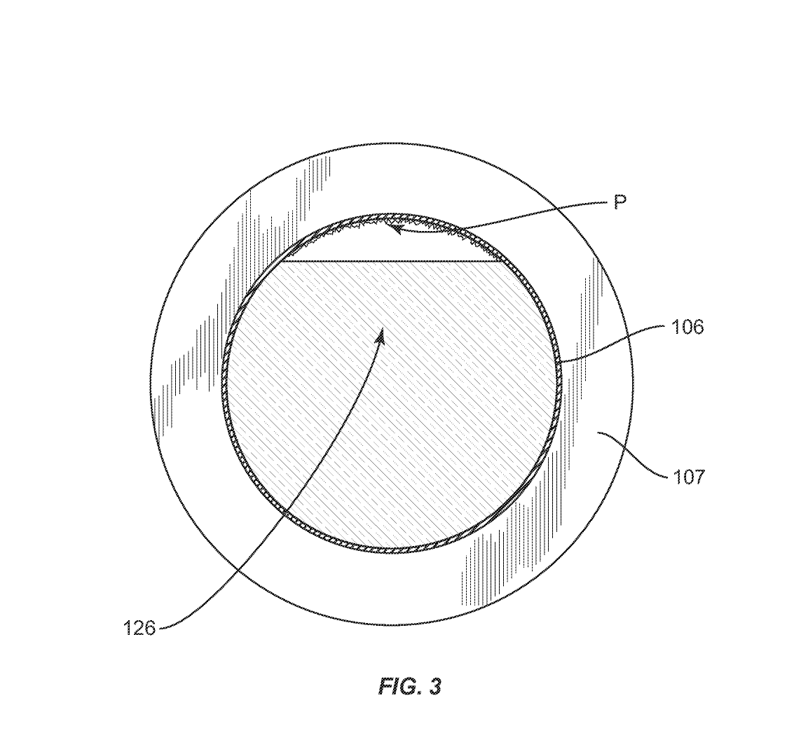

As described above, the inventors have discovered that platinum group metal particulate will form or bond beneath the flanges 107 at each end of the finer 106, as shown in FIG. 3. During the course of one exemplary production run, it was determined that the temperature, T(min inside top wall), beneath the flange was approximately 65 degrees C. lower than the highest temperature, T(max inside top wall) in the fining vessel.

Referring now to FIGS. 4 through 9, several exemplary embodiments of the present disclosure are illustrated. As shown in FIG. 4, one embodiment comprises a first conduit, or vessel 410 having a heat sink 420 formed as a cooling fin. The cooling fin also is formed of, and is compatible with the platinum group metals as the conduit or vessel, e.g., a finer 410. As will be appreciated by those skilled in the thermodynamic arts, the dimensions, i.e., the width, w, and height, h, of the cooling fin, are selected based upon the desired temperature differential and area ratios described above and the desired parameters for deposition surface area and desired temperature differential between the hot and cold spots inside the top wall portion of the conduit or vessel. As also will be appreciated, the cooling fin shown herein may be “continuously” welded longitudinally to the outer surface of the conduit or vessel 410 with a platinum or platinum alloy weld material 425, so that essentially no gaps exist between the cooling fin and the vessel or conduit outer surface, and the cooling fin is in substantially continuous and in direct metallic contact with the vessel 410 along the length of the cooling fin.

As shown in FIG. 5, an alternative embodiment of the heat sink 520 is a cooling fin formed and welded in a similar manner to the cooling fin of FIG. 4; however, the cooling fin arrangement of FIG. 5 further comprises a cooling conduit 522 affixed by a substantially continuous weld 525, or integrally formed with the cooling fin. The cross-sectional area of the cooling conduit 522, in combination with the cooling fin, are again dimensioned in accordance with the desired surface area and temperature differential between the hot and cold spots inside the top wall portion of the conduit or vessel. Depending upon these parameters, the coolant may comprise a gaseous or liquid flow, e.g. pressurized air or water, therethrough the cooling conduit 522. Also, depending upon the desired heat dissipation, the gaseous or liquid coolant flow may optionally be routed through a heat exchanger.

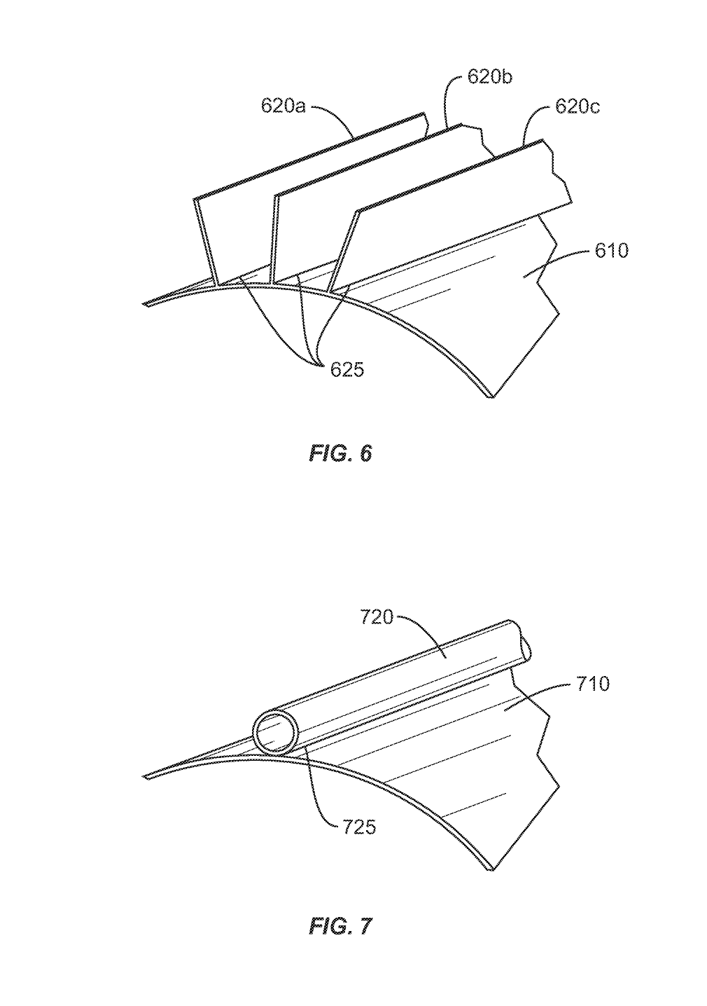

Turning now to FIGS. 6 and 7, additional alternative embodiments of the heat sink are illustrated. As shown in FIG. 6, and as will be appreciated, the heat sink 620 may comprise multiple cooling fins 620a, 620b, and 620c, each affixed by substantially continuous and in direct metallic contact, without substantial gaps, along a longitudinal extent of the outer surface of the vessel 610 with a platinum group weld material 625, and being dimensioned to achieve the desired hot and cold spots inside the top wall portion of the conduit or vessel. Accordingly, cooling fins 620a, 620b and 620c are in substantially continuous and direct metallic contact with the outer surface of vessel 610 along the length of each cooling fin. As shown in FIG. 7, the heat sink may simply comprise a cooling conduit 720 that is affixed directly, again by a continuous weld 725, along a longitudinal extent of the outer surface of the vessel 710. Again, the cross-sectional area of the cooling conduit 720 and the type of coolant are selected to achieve the desired hot and cold spots inside the top wall portion of the conduit or vessel.

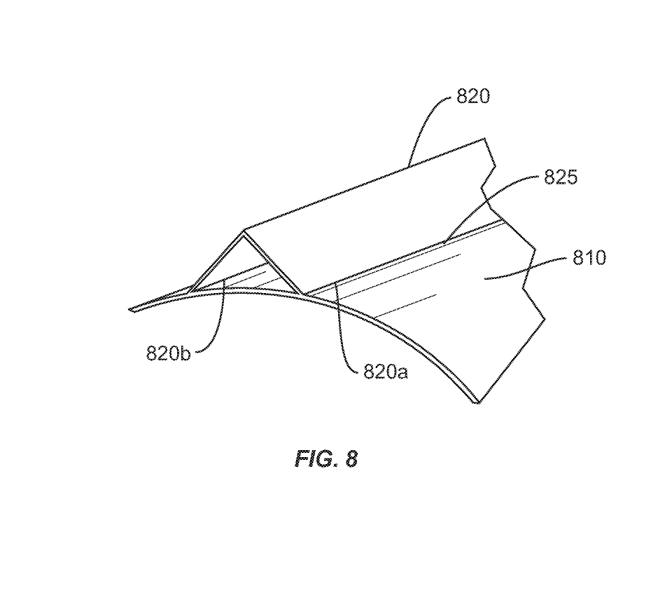

Yet another embodiment of the heat sink of the present disclosure is illustrated in FIG. 8. In this embodiment, the heat sink is formed as a coolant channel 820 having, in this particular embodiment, a pyramidal cross-section with opposed lower edges 820a and 820b that also are substantially continuously welded, without gaps, with a platinum group weld material 825 directly to the outer surface of the vessel 810 along a longitudinal extent thereof As shown, the heat sink 820 of FIG. 8 has an open bottom such that a liquid or gaseous coolant (not shown) is in direct thermal communication with the outer surface of the vessel. Again, the cross-section of this heat sink 820, and the coolant are selected based upon the parameters described above. Also again, as those skilled in the art will appreciate, the cross-sectional area of the heat sink 820, the selected fluid coolant, and the temperature, pressure and flow rate of the coolant may be varied, as understood by those skilled in the art, to obtain the desired temperature differential.

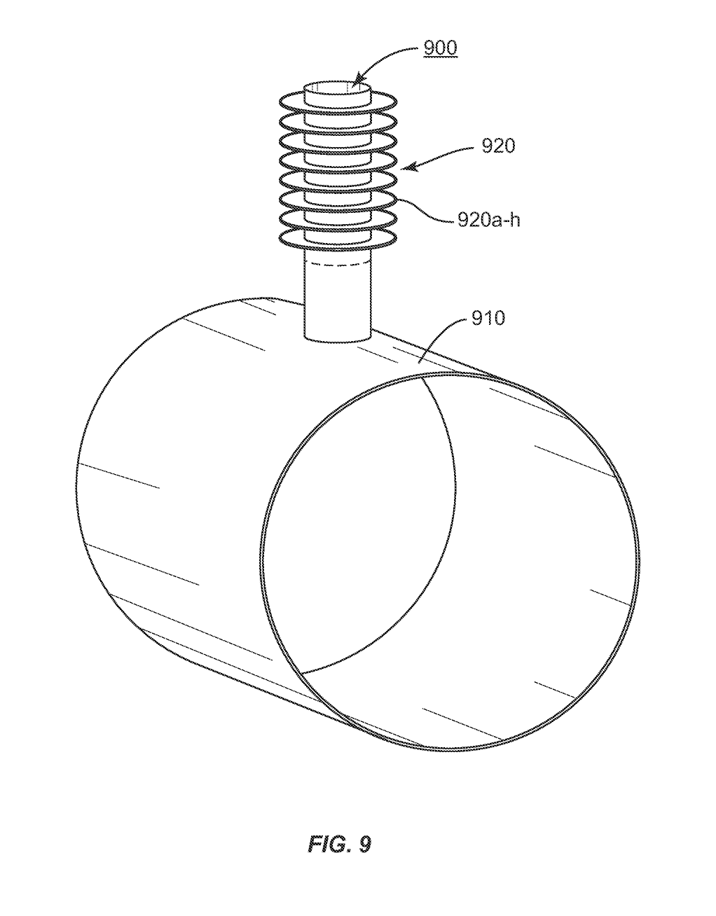

Turning lastly to FIG. 9, selected components of the glass forming system may comprise a standpipe 900 to facilitate the measurement of the height or depth of molten glass either flowing through or being processed within a vessel or conduit 910 of the glass forming system. As such, molten glass may rise a specified height upwardly within the standpipe 900, but within which the molten glass includes a free surface and at least a portion of the standpipe inner surface is not in contact with the molten glass. The inventors also have found that continuously affixing a heat sink 920, shown for example as multiple cooling fins 920a-h in FIG. 9, to the outer surface of the standpipe 900, either longitudinally, as shown in FIG. 9, circumferentially, or both, will dissipate heat from the standpipe 900, thus also causing platinum/rhodium particulate to bond with the inner surface of the standpipe 900, thus reducing the particulate which would otherwise deposit on and within the molten glass.

Unless otherwise expressly stated, it is in no way intended that the method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. For example, the various heat sink configuration described herein may be affixed to conduits by methods other than welding. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An apparatus used in the production of glass, comprising:
(a) a first conduit formed of one or more platinum group metals, the first conduit comprising a top wall portion, a side wall portion, an outer surface, and a length; and
(b) a heat sink formed of one or more platinum group metals affixed substantially continuosly to the outer surface and extending longitudinally or circumferentially along at least part of the length of the first conduit proximate the top wall portion for the dissipation of heat therefrom.

2. The apparatus of claim 1, wherein at least one of the first conduit and the heat sink comprises a platinum group metal selected from the group consisting of platinum, rhodium, palladium, iridium, rehnium, ruthenium, and osmium.

3. The apparatus of claim 1, wherein affixed substantially continously comprises at least about 70% of the length of the heat sink in direct contact with the first conduit.

4. The apparatus of claim 1, wherein the heat sink comprises one or more cooling fins affixed to and extending radially outwardly from the outer surface of the first conduit.

5. The apparatus of claim 4, wherein at least one of the cooling fins further comprises a coolant conduit affixed continuously thereto along a length of the cooling fin for the passage of a coolant therethrough.

6. The apparatus of claim 1, wherein the heat sink comprises a coolant channel having at least two sides, and opposed lower edges affixed to the outer surface of the first conduit, wherein the coolant channel forms a volume for the passage of a fluid coolant therethrough and in direct contact with the outer surface of the first conduit.

7. The apparatus of claim 1, wherein the heat sink is welded to the outer surface of the first conduit.

8. The apparatus of claim 7, wherein the heat sink is welded with a platinum group weld material.

9. The apparatus of claim 1, wherein the apparatus further comprises a second conduit in fluid communication with the first conduit, the second conduit formed of platinum group metal and having a length and an outer surface.

10. The apparatus of claim 9, wherein the second conduit extends substantially vertically upwardly from the first conduit.

11. The apparatus of claim 9, further comprising a heat sink affixed to the outer surface along at least part of the length of the second conduit for the dissipation of heat therefrom.

12. A process for minimizing the inclusion of platinum group metal particulate into molten glass during glass production in a system including at least one conduit formed of platinum group metal, the at least one conduit having a top wall portion not in direct contact with molten glass, a side wall portion in direct contact with molten glass, and an inner volume, inner and outer surfaces, a length, and a heat sink formed of platinum group metal affixed continuosly to the outer surface and extending longitudinally along at least part of the length of the first conduit proximate the top wall portion for the dissipation of heat therefrom, comprising the steps of:
(a) processing in or conveying molten glass through the conduit, wherein the inner volume has a maximum temperature, T(max inside top wall) and the inner surface proximate the heat sink has a temperature, T(min inside top wall), lower than T(max inside top wall); and
(b) establishing a selected temperature differential, between T(max inside top wall) and T(min inside top wall), wherein plaintinum group metal particulate formed during the production process will deposit on the inner surface area of the top wall portion not in contact with the molten glass.

13. The process of claim 12, wherein the deposition on the inner surface of the top wall portion comprises between 5 percent and 50 percent of the top wall surface area not in contact with the molten glass.

14. The process of claim 12, wherein the selected temperature differential, T(max inside top wall)−T(min inside top wall) is less than about 150 degrees C.

15. The process of claim 14, wherein T(max inside top wall)−T(min inside top wall) is between about 10° C. and 50° C.
